(19) United States
(12) Patent Application Publication
(10) Pub. No.: US 2014/0277622 A1
(43) Pub. Date: Sep. 18, 2014

(54) SYSTEM AND METHOD FOR BIO-SIGNAL CONTROL OF AN ELECTRONIC DEVICE

(71) Applicant: FIRST PRINCIPLES, INC., Albany, NY (US)

(72) Inventor: Keith A. Raniere, Clifton Park, NY (US)

(73) Assignee: FIRST PRINCIPLES, INC., ALBANY, NY (US)

(21) Appl. No.: 13/840,105

(22) Filed: Mar. 15, 2013

(51) Int. Cl. G05B 15/02

(52) U.S. Cl. CPC G05B 15/02
USPC 700/84

(57) ABSTRACT

A system for bio-signal control of an electronic device comprising a bio-signal sensing device for detecting a bio-signal in one of a region of a shoulder, a back or a neck operative to detect a bio-signal of a nervous system; a plurality of interfaces operative to communicate with said bio-signal sensing device and said electronic device; a command unit of an electronic interface device operative to generate a command for operation of said electronic device; and a virtual keyboard controller of said electronic device operative to implement said command without physically typing keys on a virtual keyboard is provided. An associated method is also provided.

### BACKGROUND

1. Field of Technology

The present invention relates generally to a method and system for control of an electronic device using bio-signals of the nervous system.

2. Related Art

There is a need for a system for bio-signal control of an electronic device that includes a sensor implanted in a region of a back, a region of a neck, a region of shoulder or a site of a brachial plexus for sensing bio-signals of a nervous system.

### SUMMARY

The present invention provides a system for bio-signal control of an electronic device comprising: a bio-signal sensing device for detecting a bio-signal in one of a region of a shoulder, a back or a neck operative to detect a bio-signal of a nervous system; a plurality of interfaces operative to communicate with said bio-signal sensing device and said electronic device; a command unit of an electronic interface device operative to generate a command for operation of said electronic device; and a virtual keyboard controller of said electronic device operative to implement said command without physically typing keys on a virtual keyboard.

In another aspect, the present invention provides a method for bio-signal control of an electronic device comprising: implanting a bio-signal sensing device in one of a region of a shoulder, a back or a neck; detecting a bio-signal of a nervous system; calibrating a bio-signal measuring unit of said bio-signal sensing device to reflect real-time conditions of a user; generating a command for operation of said electronic device; and generating said bio-signal by physically typing on a virtual keyboard. In a further aspect, the present invention provides a method for bio-signal control of an electronic device comprising: implanting a bio-signal sensing device within a site in a brachial plexus; detecting a bio-signal of a nervous system for a predetermined period of time by said bio-signal sensing device; calibrating a bio-signal measuring unit of said bio-signal sensing device; generating a command for operation of said electronic device; and implementing said command by a virtual keyboard controller without physically typing keys on a virtual keyboard.

### BRIEF DESCRIPTION OF THE DRAWINGS

The invention is described with accompanying reference to drawings, in which:

FIG. 1 depicts a block diagram of a bio-signal sensing device.

FIG. 2 illustrates a block diagram of an electronic interface device, including a plurality of interfaces and a communication device.

FIG. 2A illustrates a block diagram of an electronic interface device including a plurality of interface wireless transceivers and wireless communication device.

FIG. 3 depicts a system for bio-signal control of an electronic device including a bio-signal sensing device, an electronic interface device and an electronic device.

FIG. 4 depicts a system for bio-signal control of an electronic device, wherein the electronic device is a computer.

FIG. 5 illustrates a simplified block diagram of a method for bio-signal control of an electronic device, including implanting a bio-signal sensing device in the region of a shoulder, neck or back.

FIG. 6 depicts a method of bio-signal control of an electronic device, including implanting a bio-signal sensing device at a site within the brachial plexus.

FIG. 7 depicts a block diagram of detecting a bio-signal of a nervous system by a bio-signal sensing device implanted in the region of a shoulder, neck or back.

FIG. 8 depicts a block diagram for detecting nerve impulses sent to the axillary nerve by a bio-signal sensing device implanted in a region of a shoulder.

FIG. 9 depicts a block diagram for detecting a bio-signal of the nervous system by a bio-signal sensing device implanted within a brachial plexus.

FIG. 10 illustrates a block diagram for detecting bio-signals of a nervous system by a bio-signal sensing device, including continuous sensing of nerve impulses sent to dendrites of nerves.

FIG. 11 provides a block diagram for digitizing a bio-signal of a nervous system.

FIG. 12 illustrates a block diagram for digitizing a bio-signal of a nervous system by generating a digital figure for an action potential of neurons in a nerve that send sensations to a muscle.

FIG. 13 illustrates a block diagram for generating a command for operating an electronic device.

FIG. 14 through FIG. 22 illustrates examples of correlating a bio-signal of a nervous system with a command for operating an electronic device.

FIG. 23 depicts a diagram for calibrating a bio-signal measuring unit 104 to reflect real-time conditions of a user.

### DETAILED DESCRIPTION

The present invention will be described in association with references to drawings of embodiments. It will be apparent to those skilled in the art that various modifications may be made without departing from the scope of the invention.

The axon of a neuron communicates information from the brain and nerves via the movement of bio-signals (i.e., action potentials, electrical waves or nerve impulses) to other neurons, specific muscles and glands. Bio-signals move from the body of the neuron to the terminus of the axon. Bio-signals move over a synapse to receptors for specific neurotransmitters of other neurons. The dendrites of other neurons receive bio-signals from the neurotransmitter receptors. Bio-signals move from the dendrites to the body of the neurons.

FIG. 1 depicts a bio-signal sensing device 100, including a sensor 102 for continuously sensing bio-signals of a nervous system. A power source 108 may provide power for operation of the bio-signal sensing device 100. The bio-signal sensing device may include a power switch 109 for switching between the on-mode and the off-mode. A timer 103 may provide time synchronization for real-time detection of bio-signals. The bio-signal sensing device 100 may include a bio-signal measuring unit 104 for measuring, amplifying and digitizing the bio-signals of the nervous system. A calibrating unit 110, may be coupled to the bio-signal measuring unit 104 for calibrating the amplitude of the bio-signal for the bio-signal measuring unit 104. A command unit 107 may send commands to a bio-signal microcontroller 101. The microcontroller 101 may implement command received from the command unit 107. The bio-signal sensing device 100 may include a memory 105 for recording and storing the bio-signals of the nervous system and information. The bio-signal sensing device 100 further may include a bio-signal wireless transceiver 106 for transmission of bio-signal data and information.

FIG. 2 illustrates a block diagram of an electronic interface device 200. The electronic interface device may include a plurality of interfaces such as interface 202 and interface 204. The interface 202 may send and receive bio-signal data and information over a short range communication network 203. The interface 204 may receive and transmit bio-signal data and information over a long range communication network 205 using a communication device 206. The electronic interface device 200 may modify parameters (i.e., user bio-signal information) of the bio-signal sensing device 100. The electronic interface device 200 may include one or more input devices 212 (i.e., a keyboard, mouse, graphical user interface, trackball). The electronic interface device 200 may include a command unit 207 for correlating digital figures for bio-signals with command operations and a memory 201 for storing information such as bio-signal data and bio-signal correlation command information. The electronic interface device 200 further may include a controller 208 (i.e., microcontroller, central processing unit) for processing bio-signal information. A display device 209 may be capable of displaying bio-signal data and information. A modular switch 210 may be capable of activating or deactivating a power supply unit 211, which may provide power to the electronic interface device 200. An electronic interface timer 213 may be synchronized with the timer 103 of the bio-signal sensing device 100.

The plurality of interfaces may be interface wireless transceivers. For example, FIG. 2A provides an interface wireless transceiver 202 for sending and receiving bio-signal data and information over a short range communication network 203. FIG. 2A also provides an interface wireless transceiver 205 for receiving and transferring bio-signal data and information over a long range communication network 205 using a communication device 206, which may be wireless.

FIG. 3 depicts a system for bio-signal control of an electronic device 300 including a bio-signal sensing device 100, an electronic interface device 200 and an electronic device 300. According to the system for bio-signal control of an electronic device 300, the electronic interface device 200 may be connected to at least one output device such as the electronic device 300 (i.e., a computer, a joystick controller). The controller 208 of the electronic interface device 200 may be capable of sending commands to the command unit 207. The command unit 207 may be capable of implementing the commands by generating output control signals for operation of the electronic device 300.

According to the system in FIG. 4, the electronic device may be a computer 300a. The interface wireless transceiver 202 of the electronic interface device 200 may be capable of receiving bio-signal data, information and communications from the bio-signal wireless transceiver 106 of the bio-signal sensing device 100 over a short distance communication network 203. The interface wireless transceiver 204 may be capable of receiving bio-signal data, information and communications from the computer 300a over a long range communication network 205 such as a wide area network. The interface wireless transceiver 204 may be capable of transmitting bio-signal data, information and communications to the computer 300a over the long range communication network 205 (wide area network, the Internet) through a communication device 206 (i.e., wireless telephone). Bio-signal data, information and communications may be transmitted in real-time.

FIG. 5 illustrates a simplified block diagram of a method for bio-signal control of an electronic device 300. A bio-signal sensing device 101, implanted in a region of a shoulder, a neck or a back, detects a bio-signal of a nervous system (step 501). A bio-signal measuring unit 104 may digitize the bio-signal of the nervous system (step 502). A command unit 207 may generate a command for operating the electronic device 300 (step 503). The electronic device may operate by typing keys on a virtual keyboard (step 504). A calibration unit 110 may calibrate the bio-signal measuring unit 104 to reflect real-time conditions of the user (step 505).

In accordance with FIG. 6, the bio-signal sensing device 100 may be implanted or receive signals proximal through a topical sensor at a site within the brachial plexus in (step 601). The brachial plexus may comprise nerve fibers derived from spinal roots along the vertebrae at C5-T1. The bio-signal sensing device 100 may be implanted or receive signals proximal through a topical sensor proximal to an axillary nerve, a dorsal scapular nerve, a suprascapular nerve, an upper subscapular nerve, a lower subscapular nerve, a subclavian nerve, a lateral pectoral nerve, a median pectoral nerve, a radial nerve, a thoracodorsal nerve, an ulnar nerve, a median nerve, a medial antebrachial cutaneous nerve, a medial cutaneous nerve or a musculocutaneous nerve.

FIG. 7 depicts a block diagram of a method for bio-signal control of an electronic device 300 comprising detecting a bio-signal of a nervous system by a bio-signal sensing device 100 implanted in the region of a shoulder, neck or back. A power switch 109 may turn the power source 108 on or turn the power source 108 off. The sensor 102 of the bio-signal sensing device 100 may sense continuously bio-signals of the nervous system (step 701). The sensor 102 of the bio-signal sensing device 100 may sense continuously bio-signals from nerves of the neck, the shoulder, the back, the axilla, the upper arm, the forearm, the rotator cuff, the wrist, the palm, the thumb, the forefinger, the middle finger, the fourth finger and the fifth finger. The timer 103 of the bio-signal sensing device 100 is synchronized to the time for an electronic interface timer 213 of the electronic interface device 200. The bio-signal measuring unit 104 measures the bio-signal of the nervous system for a predetermined period (step 702). The memory 103 records and stores the bio-signals of the nervous system (step 703). The bio-signal microcontroller 101 of the bio-signal sensing device 100 receives command instructions from the command unit 107 and implements command instructions.

FIG. 8 depicts an example of a bio-signal sensing device 100 implanted in a region of a shoulder for detecting nerve impulses sent to the axillary nerve. The sensor 102 of the bio-signal sensing device 100 continuously senses nerve impulses of the axillary nerve, which supplies nerves of the arm and shoulder (step 801). The axillary nerve derives from roots extending along the vertebral column at C5 and C6. The axillary nerve extends along the neck. The axillary nerve further extends below the deltoid muscle or triangular-shaped muscle surrounding the shoulder. The axillary nerve sends nerve impulses to the teres minor muscle and the deltoid muscle. The axons in neurons of the axillary nerve transport bio-signals of the nervous system from the joints of the shoulders. The axons in neurons of the axillary nerve also transport bio-signals of the nervous system from skin surrounding the deltoid muscles. The bio-signal measuring unit 104 measures the nerve impulses of the axillary nerve for a predetermined time period (step 802). The memory 105 of the bio-signal sensing records and stores the nerve impulse measurements of the bio-signal measuring 104 (step 803).

FIG. 9 depicts a block diagram of a method for bio-signal control of an electronic device 300 comprising detecting of the bio-signal of the nervous system by the bio-signal sensing device 100 implanted within a brachial plexus. For example, the sensor 102 of the bio-signal sensing device 100 senses continuously bio-signals such as action potentials of neurons in the upper subscapular nerve, lower subscapular nerve, subclavian nerve, axillary nerve, thoracodorsal nerve or dorsal scapula nerve in accordance with step 901. The bio-signal measuring unit 104 measures the action potentials of the neurons in the upper subscapular nerve, lower subscapular nerve, subclavian nerve, axillary nerve, thoracodorsal nerve or dorsal scapula nerve for a predetermined time period in step 902. The memory 105 records and stores measurements for the action potentials of the neurons in the upper subscapular nerve, lower subscapular nerve, subclavian nerve, axillary nerve, thoracodorsal nerve or dorsal scapula nerve (step 903).

The bio-signal sensing device 100 may detect bio-signals (i.e., action potentials, electrical waves or nerve impulses) communicated to various nerves. For example in FIG. 10, the sensor 102 of the bio-signal sensing device 100 may sense continuously nerve impulses sent to dendrites of the radial nerve, median nerve, ulnar nerve, musculocutaneous nerve, medial antebrachial cutaneous nerve or sub clavian nerve. The radial nerve is derived from spinal roots along the vertebral column at C5, C6, C7 C8 and T1 (step 1001). The radial nerve supplies nerves to the fingers, thumb, wrist, elbow extensors and arm. The median nerve innervates the finger flexors, thumb and elbow. The ulnar nerve furnishes nerves of the finger flexors and wrist and the musculocutaneous nerve supplies nerves to elbow flexors and upper arm.

The sensor 102 of the bio-signal sensing device 100 may sense bio-signals of nerves providing sensation to the subscapular muscle, teres major muscle, teres minor muscle, deltoid muscle, latissimus dorsi muscle, flexor pectoralis muscle, pronator teres muscle, flexor carpi radiales, abductor pollicis, abductor pollicis longus, abductor pollicis brevis, extensor pollicis longus, extensor pollicis brevis, flexor pollicis longus, flexor pollicis brevis, oppenens pollicis, tricep brachii muscle, flexor carpi ulnaris, palmaris longus, carpi ulnaris muscle, flexor digitories profundus muscle and lumbrical muscle.

FIG. 11 provides a block diagram of a method for bio-signal control of an electronic device 300 comprising digitizing a bio-signal of a nervous system. The bio-signal measuring unit 104 may amplify the bio-signal of the nervous system (step 1101). The bio-signal measuring unit 104 may convert an analog of the bio-signal to a digital figure (step 1102). The memory 105 may store the digital figure for the analog of the bio-signal (step 1103). The bio-signal transceiver 106 of the bio-signal sensing device 100 may transmit the digital figure for the bio-signal to the interface wireless transceiver 202 of the electronic interface device 200 (step 1104).

In FIG. 12, an analog for an action potential of neurons that sends sensations to a muscle may be converted to a digital figure by the bio-signal measuring unit 104. For example, an action potential of neurons in the axillary nerve of the shoulder may send sensations to a deltoid muscle. Further, an action potential of neurons in the axillary nerve of rotator cuff may send sensations to a teres minor muscle. An action potential of neurons in the median nerve of the forearm may provide sensations to a forefinger. The ulnar nerve derives from roots C7, C8 and T1. An action potential of neurons in the ulnar nerve of the thumb may send sensations to the flexor carpi ulnaris muscle or an action potential of neurons in the ulnar nerve of a forearm may send sensations to a flexor digitorum profundus muscle. An action potential of neurons in the radial nerve of the elbow joint may send sensations to an anconeus muscle. With respect to neurons of a radial nerve of an arm, an action potential of neurons may send sensations to a triceps brachii muscle. However, an action potential of neurons in the radial nerve of a forearm may send sensations to a brachioradialis muscle. An action potential of neurons in the radial nerve of a wrist joint may send sensations to an extensor carpi radialis longus muscle. An analog for each action potential may be converted to a digital figure by the bio-signal measuring unit 104.

In FIG. 13, a command may be generated for operating an electronic device. The interface wireless transceiver 204 wirelessly may receive the bio-signals of the nervous system, data and information from the bio-signal wireless transceiver 106 of the bio-signal sensing device 100 over a short range wireless communication network 203 such as Bluetooth, IEEE802.11, a wireless local area network (WLAN) or wireless metropolitan network (WMAN) linked to the electronic interface device 200 (step 1301). The memory 201 of the electronic interface device 200 may store bio-signal data, digital figures and information (step 1302). In accordance with FIG. 13, the command unit 207 of the electronic interface device 200 may correlate the digital figure for the analog of the specific bio-signal to a command for operating an electronic device 300 such as a computer or microcomputer (step 1303). The memory 201 (i.e, read-only memory, random access memory) of the electronic interface device 200 may store the correlating command information (step 1304). The interface wireless transceiver 204 may send the command to the electronic device 300 over a long range communication network 205 using a wireless communication device 206 step 1305). A virtual keyboard controller 302 of a virtual keyboard 303 may implement the command on the display screen 301 without the user physically typing the keys on the virtual keyboard 303 (step 1306).

FIG. 14 illustrates an example of a method for bio-signal control of an electronic device 101, including correlating a digital figure with a command for operating the electronic device. The digital figure generated from an analog for an action potential of neurons in the median nerve of the forearm that send sensations to the forefinger may be communicated to the interface wireless transceiver 204 of the electronic interface device 200 (step 1401). The command device 207 of the electronic interface device 200 may correlate the digital figure, generated from an analog for an action potential of neurons in the median nerve of the forearm, with an “enter” command for operating the electronic device 300 (step 1402). The memory 201 of the electronic interface device 200 may store the digital figure and correlating “enter” command information (step 1403). The interface wireless transceiver 204 may send the “enter” command to the electronic device 300 over a long range communication network 205 using a wireless communication device 206 (step 1404). A virtual keyboard controller 302 of the virtual keyboard 303 may implement the “enter” command on the display screen 301 (step 1505).

In FIG. 15, a digital figure generated from an analog for an action potential of the neurons in the ulnar nerve of the thumb that send sensations to the flexor carpi ulnaris muscle may be correlated by the command unit 207 to the “backspace” command for operating the electronic device 300 (step 1502). FIG. 16 depicts an example of a digital figure generated from an analog for an action potential of neurons in the radial nerve of the arm. The radial nerve sends sensations to the triceps brachii muscle. The command unit 207 may correlate the digital figure to by a left arrow command (step 1603). According to FIG. 17, a digital figure generated from an analog for an action potential of neurons in the radial nerve of the elbow joint may be correlated by the command unit 207 to a down arrow command for operating the electronic device 300 (step 1702). The radial nerve of the elbow joint sends sensations to the anconeus muscle.

After a digital figure is generated from an analog for an action potential of neurons in the axillary nerve of the shoulder that send sensations to the deltoid muscle, the command unit 207 may correlate the digital figure to the first letter of the alphabet “a” for operating the electronic device 300 (step 1802 of FIG. 18). In FIG. 19, a digital figure generated from an analog for an action potential of neurons in the axillary nerve of rotator cuff that send sensations to the teres minor muscle may be correlated to the second letter of the alphabet “b” on the keyboard display screen using the command unit (step 1902). Further, a digital figure generated from an analog for an action potential of neurons in the ulnar nerve of the forearm that send sensations to the flexor digitorum profundus muscle may be correlated by the command unit to the a punctuation mark such as an exclamation point “!” (step 2002 of FIG. 20). According to step 2102 of FIG. 21, a digital figure generated from an analog for an action potential of neurons in the radial nerve of the forearm that send sensations to the brachioradialis muscle may be correlated by the command unit to the number “1”. In another example, a digital figure generated from an analog for an action potential of neurons in the radial nerve of the wrist joint that send sensations to the extensor carpi radialis longus muscle may be correlated by the command unit to the number “2” (step 2202 of FIG. 22).

In FIG. 23, a bio-signal measuring unit 104 may be calibrated to reflect real-time conditions of a user. A personal digital assistant (PDA) 400 is linked to the bio-signal wireless transceiver 106 of the bio-signal sensing device 100 (step 2301). The user may send commands to the bio-signal sensing device 100 from the personal digital assistant (PDA) for calibrating the bio-signal measuring unit 110 of the bio-signal sensing device 100 over a wireless communication network 401 (step 2302). The microcontroller 101 processes the commands sent to the bio-signal sensing device 100 and the sensor 102 senses bio-signals of the user (step 2303). The bio-signal measuring device 110 measures the bio-signals of the user for a predetermined period (2304). The calibrating unit 110 adjust the amplitude of the bio-signals measuring unit 110 based on real-time conditions of the user (2305). In another aspect, the calibrating unit 108 may continuously monitor and adjust the amplitude of the bio-signal measuring unit (step 2306).

What is claimed is:

1. A system for bio-signal control of an electronic device comprising:
a bio-signal sensing device for detecting a bio-signal in one of a region of a shoulder, a back or a neck operative to detect a bio-signal of a nervous system;
a plurality of interfaces to communicate with said bio-signal sensing device and said electronic device;
a command unit of an electronic interface device operative to generate a command for operation of said electronic device; and
a virtual keyboard controller of said electronic device operative to implement said command without physically typing keys on a virtual keyboard.

2. The system of claim 1, wherein said bio-signal sensing device comprises a sensor operative to sense said bio-signal of said nervous system.

3. The system of claim 1, wherein said bio-signal sensing device comprises a timer operative to synchronize said bio-signal sensing device and an electronic interface timer of said electronic interface device.

4. The system of claim 1, wherein said bio-signal sensing device comprises a bio-signal measuring unit operative to measure said bio-signal of said nervous system.

5. The system of claim 1, wherein said bio-signal sensing device comprises a bio-signal measuring unit operative to amplify said bio-signal of said nervous system.

6. The system of claim 1, wherein said bio-signal sensing device comprises a bio-signal measuring unit operative to digitize said bio-signal of said nervous system.

7. The system of claim 1, wherein said bio-signal sensing device comprises a calibration unit operative to calibrate a bio-signal measuring unit.

8. The system of claim 1, wherein said bio-signal sensing device comprises a wireless bio-signal transceiver operative to transmit bio-signal information of said nervous system to said electronic interface device.

9. The system of claim 8, wherein said bio-signal sensing device further comprises a memory operative to store said bio-signal information of said nervous system.

10. The system of claim 1, wherein said bio-signal sensing device comprises a command unit operative to communicate a command to a bio-signal microcontroller and said bio-signal microcontroller is operative to implement said command.

11. The system of claim 1, wherein said plurality of interfaces are wireless transceivers of said electronic interface device.

12. The system of claim 1, further comprising a short range communication network operative to receive bio-signal information communicated to said short range communication network by at least one of said plurality of interface wireless transceivers.

13. The system of claim 1, further comprising a long range communication network operative to receive bio-signal information communicated by at least one of said plurality of interfaces using a wireless communication device.

14. The system of claim 1, wherein said electronic interface device further comprises
at least one input device operative for inputting data,
a memory operative to store bio-signal information of said nervous system;
a controller operative to process bio-signal information; and
a display device operative to display bio-signal information.

15. A method for bio-signal control of an electronic device comprising:
implanting a bio-signal sensing device in one of a region of a shoulder, a back or a neck;
detecting a bio-signal of a nervous system;
calibrating a bio-signal measuring unit of said bio-signal sensing device to reflect real-time conditions of a user;
generating a command for operation of said electronic device; and
generating said bio-signals by physically typing on a virtual keyboard.

16. The method of claim 15, wherein said detecting includes
sensing continuously said bio-signal of said nervous system with a sensor of said bio signal sensing device;
measuring said bio-signal of said nervous system with said bio-signal measuring unit; and
storing bio-signal information in a memory of said bio-signal sensing device.

17. The method of claim 15, further comprises digitizing said bio-signal of said nervous system, including amplifying said bio-signal of said nervous system; and converting an analog of said bio-signal of said nervous system to a digital figure.

18. The method of claim 15, wherein said calibrating includes
linking a personal digital assistant to a bio-signal wireless transceiver of said bio signal sensing device;
sending a command for calibration of said bio-signal measuring unit to said bio-signal sensing device from said personal digital assistant over a long range wireless communication network;
processing said command for calibration of said bio-signal measuring unit by a microcontroller of said bio-signal sensing device;
sensing said bio-signal of said nervous system for said individual user;
measuring said bio-signal of said nervous system for said individual user; and
adjusting amplitude of said bio-signal measuring unit for said individual user.

19. The method of claim 15, wherein said generating includes
correlating a digital figure for an analog of said bio-signal to said command for operation of said electronic device; and
storing correlation command information in a memory of an electronic interface device.

20. The method of claim 16, wherein said bio-signal is selected from the group consisting of:
an action potential of a nerve of a neck;
an action potential of a nerve of a shoulder;
an action potential of a nerve of a back;
an action potential of a nerve of an axilla; and
an action potential of a nerve of an upper arm.

21. The method of claim 16, wherein said bio-signal is selected from the group consisting of:
an action potential of a nerve of a forearm;
an action potential of a nerve of a rotator cuff; and
and an action potential of a nerve of a wrist.

22. The method of claim 16, wherein said bio-signal is selected from the group consisting of:
an action potential of a nerve of a palm;
an action potential of a nerve of a thumb;
an action potential of a nerve of a forefinger;
an action potential of a nerve of a middle finger;
an action potential of a nerve of a fourth finger; and
an action potential of a nerve of a fifth finger.

23. The method of claim 16, wherein said bio-signal is an action potential sent to a dendrite of a nerve of said nervous system.

24. The method of claim 15, further comprising synchronizing the time of said bio-signal sensing device with the time of said electronic interface device.

25. The method of claim 15, wherein said operating includes
communicating said command for operation to said electronic device over a long range communication network using a wireless communication device; and
implementing said command on a display screen by a virtual keyboard controller of said virtual keyboard.

26. The method of claim 15, further comprising
receiving a command instruction from a command unit of said bio-signal sensing device; and
implementing said command instruction by said command unit of said bio-signal sensing device.

27. The method of claim 15, further comprises transmitting a digital figure for said bio-signal to at least one of a plurality of interface wireless transceivers of an electronic interface device.

28. The method of claim 15, wherein said generating further includes
receiving wirelessly bio-signal information of said nervous system by at least one of a plurality of interface wireless transceivers over a short range wireless communication network from a bio-signal wireless transceiver; and
storing said bio-signal information in said memory of said electronic interface device.

29. The method of claim 15, further comprising communicating bio-signal information of said nervous system by at least one of a plurality of interface wireless transceivers over a long range communication network.

30. A method for bio-signal control of an electronic device comprising:
implanting a bio-signal sensing device within a site in a brachial plexus;
detecting a bio-signal of a nervous system for a predetermined period of time by said bio-signal sensing device;
calibrating a bio-signal measuring unit of said bio-signal sensing device;
generating a command for operation of said electronic device; and
implementing said command by a virtual keyboard controller by typing keys on a virtual keyboard.

31. The method of claim 30, wherein said implanting within said site in said brachial plexus is proximal to an axillary nerve, a dorsal scapular nerve, a suprascapular nerve, an upper subscapular nerve, a lower subscapular nerve, a subclavian nerve, a lateral pectoral nerve, a median pectoral nerve, a radial nerve, a thoracodorsal nerve, an ulnar nerve, a median nerve, a medial antebrachial cutaneous nerve, a medial cutaneous nerve or a musculocutaneous nerve.
